(19) United States
(12) Patent Application Publication
(10) Pub. No.: US 2014/0323282 A1
(43) Pub. Date: Oct. 30, 2014

(54) METHOD OF AND APPARATUS FOR ERECTING CONTAINERS

(71) Applicant: GOSSAMER MACHINERY (PTY) LTD, SOMERSET WEST (ZA)

(72) Inventors: Rudolf Georg Janse Van Rensburg, Somerset West (ZA); Charl Nieder-Heitmann, Somerset West (ZA)

(21) Appl. No.: 14/362,019

(22) PCT Filed: Nov. 28, 2012
(86) PCT No.: PCT/IB2012/056794

§ 371 Date: May 30, 2014

(30) Foreign Application Priority Data
Dec. 1, 2011 (ZA) 201108826

(51) Int. Cl. B31B 1/26

(52) U.S. Cl. CPC B31B 1/26
USPC 493/162

(57) ABSTRACT

Apparatus and a method are provided for erecting a container (10) from a blank of sheet material by folding the blank to form a bottom (12), walls (14,16) and pillars (22) in its corners (18). A ledge flap (26) is folded by pivotal movement of a pivot arm (30) to form a ledge (40) and the pivot arm (30) is moved in an outwardly direction (36) until it presses ends (23) of tabs (20) from which the pillars (22) have been folded, against the insides of the adjacent walls (14,16) to bond to the walls.

### FIELD OF THE INVENTION

This invention relates to erecting containers from container blanks cut from sheet material. In particular, the invention relates to the erection of shallow, open-topped containers known in the trade as “trays”, that are suitable for the transport and handling of fresh produce.

### BACKGROUND TO THE INVENTION

Trays for the fresh produce industry typically include upright columns or pillars in their corners which assist in bearing compressive loads from containers stacked on top of one another and these pillars are typically triangular in cross-section and are folded from tabs extending from the end walls or side walls of the containers. These containers also typically include ledges extending along the upper edges of the side walls or the end walls and that partially close the open tops of the containers. The ledges provide stability for the container walls from which they extend and also enhance the appearance of the containers, e.g. by concealing the upper ends of the pillars.

When a tray of the type described above is erected in an automated process from a blank, the process typically includes a first stage in which the pillars are folded from pillar tabs and are adhesively bonded to the adjacent parts of the blank that will form walls of the container. The process then includes a second stage, which takes place in a second location, in which side walls and end walls are formed by a mandrel pressing down on the blank and the ledges are formed and are secured in position.

The reason why two forming stages are required, is that a pivoted arm that is configured to press the end of the pillar tab against the inside of the wall would be obstructed by the ledge if it had already been formed. The pivot arms that hold the pillar tab ends against the wall insides and the pivot arms that form the ledges need to operate in the same corner regions of the containers and accordingly, the container needs to shift from one position where the first stage is performed, to another position where the second stage is performed.

The present invention seeks to provide for the erection of such a container in which the formation of the pillars and the ledges takes place in a single operation and in a single location—which results in more cost-effective erection of the containers.

### SUMMARY OF THE INVENTION

According to one aspect of the present invention there is provided a method of erecting a container from a blank of sheet material, said method comprising the steps of:
folding parts of the blank relative to a bottom of the container, to form a first pair of opposing walls and a second pair of opposing walls of the container, with adjacent walls from each of said pairs forming a corner;
folding a pillar tab in each of the corners to form a pillar on an inside of the corner, with an end of the pillar tab adjacent to the inside of one of the walls from the first pair of walls;
pivoting a pivot arm about a pivot axis that extends generally parallel to an upper edge of said wall;
folding an upper edge of said wall with said pivot arm, to form a ledge;
moving the pivot arm in an outward direction that extends generally perpendicular to said wall; and
pressing said end of the pillar tab against the inside of said wall with part of said pivot arm.

The pivot arm may be attached to a pivot shaft that extends along the pivot axis, the step of pivoting the pivot arm about the pivot axis may include turning the pivot shaft and the step of moving the pivot arm in the outward direction may include moving the pivot shaft in the outward direction.

The pivot arms attached to the shaft may fold the entire ledge extending along the upper edge of the wall and may press the ends of two pillar tabs against the inside of the wall, simultaneously. (These two pillar tabs being associated with the pillars formed in the corners at opposing ends of the wall.)

The pivot arm may include a first press formation and a second press formation, the step of folding the upper edge of the wall to form the ledge may include pressing the first press formation against the upper edge of the wall during the pivotal movement of the pivot arm and the step of pressing the end of the pillar tab against the inside of the wall may include pressing the second press formation against the end of the pillar tab.

The step of folding the pillar tab may include pivoting a pillar forming part about an axis that extends generally parallel to the corner in which the pillar is folded—e.g. in a horizontal pivoting movement.

According to one aspect of the present invention there is provided apparatus for erecting a container from a blank of sheet material, said apparatus including:
at least one pivot arm that is pivotally mounted to pivot about a pivot axis that extends generally parallel to an upper edge of a container wall and to fold the upper edge of said wall during said pivotal movement, to form a ledge extending from the upper edge of said wall; and
a shift arrangement, configured to move the pivot arm in an outwardly direction that extends generally perpendicular to said wall, to press an end of a pillar tab against an inside of said wall with part of the pivot arm.

The pivot arm may be attached to a pivot shaft that extends along the pivot axis and the shift arrangement may be configured to move the pivot shaft in the outwardly direction.

A plurality (typically two) of the pivot arms may be attached to the pivot shaft and the pivot arms may be configured to fold the entire ledge during turning of the shaft and to press the ends of two of the pillar tabs simultaneously against the inside of the wall.

The pivot arm may include a first press formation that is configured to press against the upper edge of the wall to form the ledge, and a second press formation that is configured to press the end of the pillar tab against the inside of said wall and the first and second press formations may be oriented perpendicularly to each other.

### BRIEF DESCRIPTION OF THE DRAWINGS

For a better understanding of the present invention, and to show how the same may be carried into effect, the invention will now be described by way of non-limiting example, with reference to the accompanying drawings in which:

FIGS. 1A to 1D show three-dimensional views of steps in a method according to the present invention, for the erection of a container; and

FIGS. 2A to 2D show diagrammatic sectional side views of the steps shown in FIGS. 1A to 1D—drawings with corresponding suffixes showing different views of the same steps.

### DETAILED DESCRIPTION OF THE DRAWINGS

Referring to the drawings, a container in the form of a carton known in the industry as a “tray” that is erected using a method according to the present invention and is generally indicated by reference by numeral 10, during different steps of being erected.

The tray 10 is erected from a blank that has been cut from suitable sheet material, such as corrugated paperboard, and the tray has been partly erected in preceding steps according to methods known in the art, including: cutting and scoring the blank, applying adhesive to selected parts of the blank, pressing the blank with a mandrel to fold parts of the blank into a bottom 12, a first pair of opposing walls in the form of end walls 14 (of which only one is shown in the drawings) and a second pair of opposing walls in the form of side walls 16, with corners 18 formed at each meeting of a side wall and an end wall.

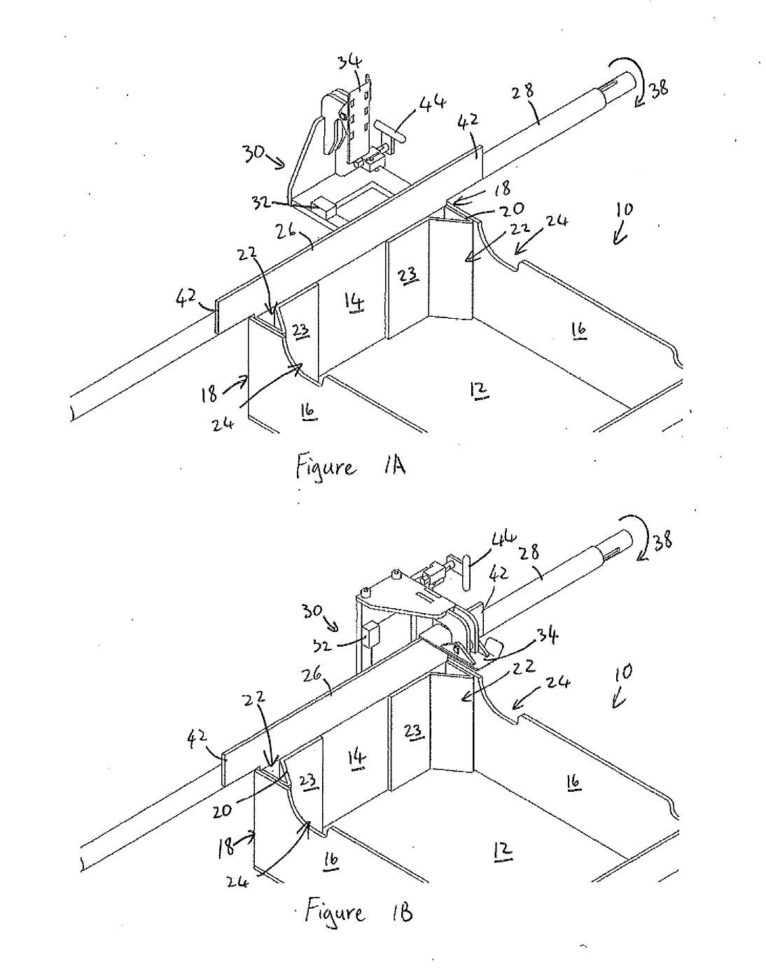

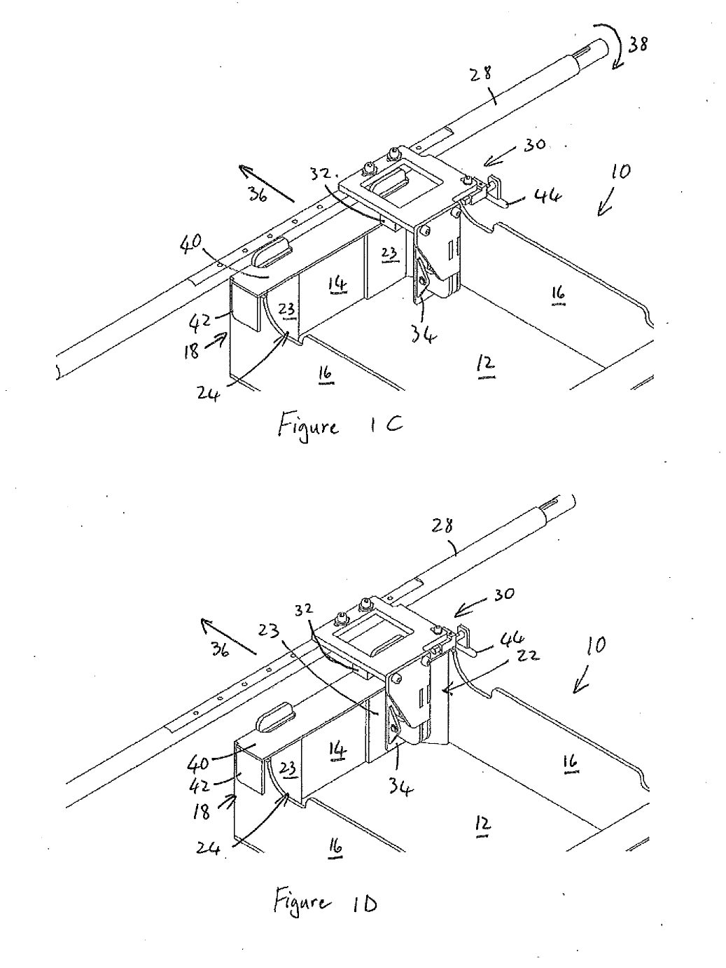

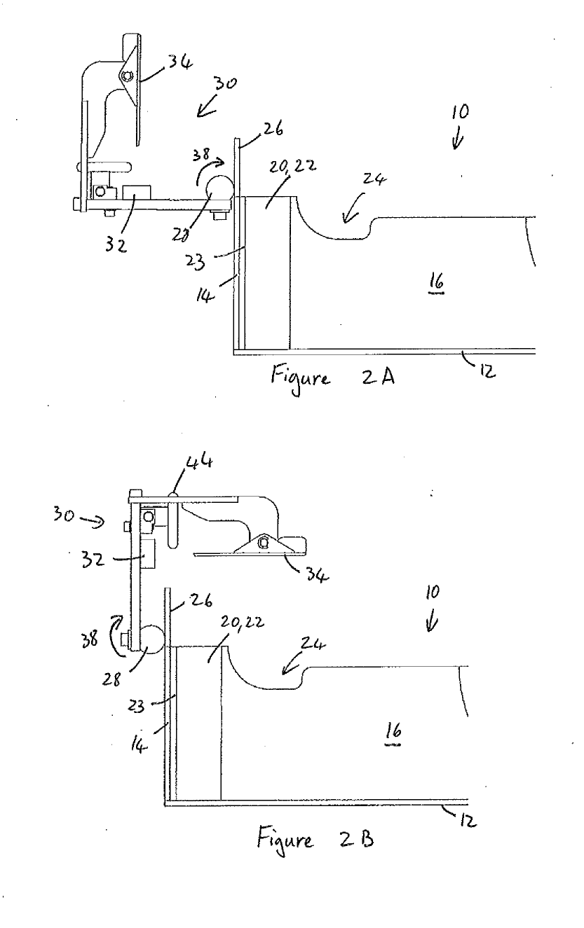

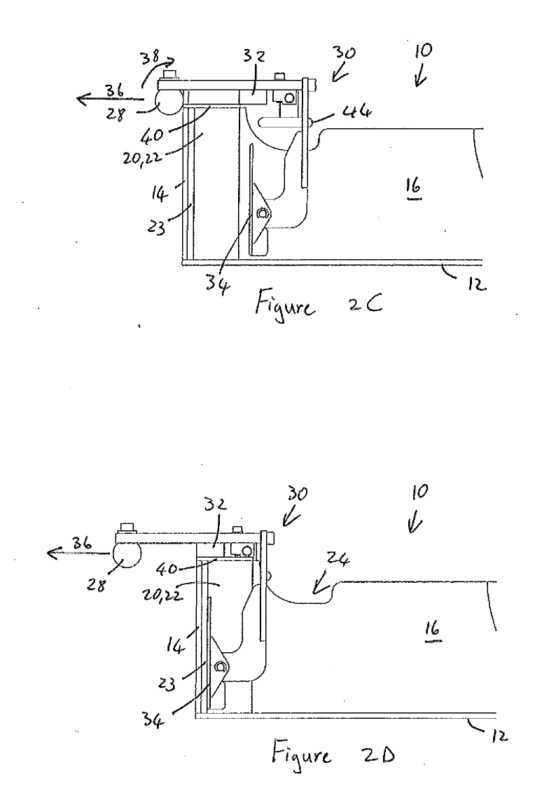

Pillar tabs 20 extend from opposing ends of the end wall 14 and are folded to form pillars 22 with triangular profiles, each pillar extending on the inside of its associated corner 18. Each of the pillars 22 is folded by a horizontal pivotal movement of a suitably shaped pillar folding element known in the art, which pivots about an upright axis (i.e. about an axis that extends parallel to the adjacent corner 18) and the element passes through a recess 24 in the upper edge of the side wall 16. Once the pillars 22 have been folded, the ends 23 of the pillar tabs 20 are adjacent the inside of the end wall, as shown in FIGS. 1A and 2A. The ends of each side wall 16 are attached with adhesive to the outsides of the adjacent pillars 22. An upper edge of the end wall 14 forms a ledge tab 26 that extends upwards initially, as also shown in FIGS. 1A and 2A.

A shaft 28 extends along a pivot axis, generally parallel to the upper edge of the end wall 14, at a position immediately on the outside of said upper edge. A pivot arm 30 is attached to the shaft 28 and is generally L-shaped in side view, with a first press formation 32 and a second press formation 34 that are oriented perpendicularly to each other. The apparatus according to the invention typically includes two shafts 28, one disposed at each end wall 14 and on each shaft, there are typically two pivot arms 30, but for ease of illustration, only one shaft and one pivot arm are shown in the drawings. The shaft 28 is connected to means for turning it reciprocally about the pivot axis and a shift mechanism (not shown) is provided that can shift the shaft 28 in an outwardly direction, shown in the drawings by reference number 36 and that extends perpendicularly to the end wall, and back.

Referring to FIGS. 1B and 1C, in sequence and also FIGS. 2B and 2C, in sequence, the shaft 28 is turned in the direction shown by reference numeral 38 and at the same time, the pivot arm is pivoted so that its first press formation 32 folds the ledge tab 26 to form a ledge 40. In preferred embodiments, where more than one pivot arm 30 are provided on the shaft 28, the pivot arms fold the entire ledge tab 26 to form the ledge 40 in a single movement.

During this stage, end flaps 42 of the ledge 40 are attached to be bonded to the outsides of the side walls 16 in upper corner regions, with adhesive, to hold the ledge in place. The end flaps 42 are folded in part by protuberances 44 on the pivot arms and the end flaps are then pressed against the side walls 16 to allow the adhesive to bond.

Referring to FIGS. 1D and 2D, once the ledge 40 has been folded, the shift mechanism moves the shaft 28 and pivot arm 30 outwards 36 and at the same time, the second press formation 34 abuts the inside of the end 23 of the pillar tab 20 and presses it firmly against the inside of the end wall 14, so that adhesive applied to the outside of the end 23 bonds to the inside of the end wall, to secure the pillar 22 in place. In preferred embodiments where two pivot arms 30 are provided on each shaft 28, the second press formations 34 of the two pivot arms press the ends 23 of the pillar tabs 20 of the pillars 22 in the corners 18 at opposing ends of the end wall 14 against the inside of the end wall, simultaneously.

At the end of the step shown in FIGS. 1D and 2D, the movements of the shaft 28 and pivot arm 30 are reversed and the tray 10 is removed.

The movements of the shaft 28 and pivot arm 30 described above can be achieved in a variety of ways—one of which is by way of pneumatic pistons.

The invention has been described with reference to trays 10, but applies equally in respect of any containers that include pillars 22 and ledges 40. Further, the roles of the side walls 16 and end walls 14 as described above can be interchanged.

1. A method of erecting a container from a blank of sheet material, said method comprising the steps of:
folding parts of the blank relative to a bottom of the container, to form a first pair of opposing walls and a second pair of opposing walls of the container, with adjacent walls from each of said pairs forming a corner;
folding a pillar tab in each of the corners to form a pillar on an inside of the corner, with an end of the pillar tab adjacent to the inside of one of the walls from the first pair of walls;
pivoting a pivot arm about a pivot axis that extends generally parallel to an upper edge of said wall from the first pair of walls;
folding an upper edge of said wall with said pivot arm, to form a ledge;
moving the pivot arm in an outward direction that extends generally perpendicular to said wall from the first pair of walls; and
pressing said end of the pillar tab against the inside of said wall from the first pair of walls, with part of said pivot arm.

2. A method according to claim 1, wherein the pivot arm is attached to a pivot shaft that extends along the pivot axis, the step of pivoting the pivot arm about the pivot axis includes turning the pivot shaft and the step of moving the pivot arm in the outward direction includes moving the pivot shaft in the outward direction.

3. A method according to claim 2, wherein the pivot arms attached to said shaft fold the entire ledge extending along the upper edge of said wall from the first pair, and press the ends of two pillar tabs against the inside of said wall, simultaneously, said two pillar tabs being associated with the pillars formed in the corners at opposing ends of said wall.

4. A method according to claim 1 or claim 2, wherein the pivot arm includes a first press formation and a second press formation, the step of folding the upper edge of said wall from the first pair, to form the ledge includes pressing the first press formation against the upper edge of the wall during said pivotal movement of the pivot arm and the step of pressing the end of the pillar tab against the inside of said wall includes pressing the second press formation against the end of the pillar tab.

5. A method according to claim 1 or claim 2, wherein the step of folding the pillar tab includes pivoting a pillar forming part about an axis that extends generally parallel to the corner in which the pillar is folded.

6. Apparatus for erecting a container from a blank of sheet material, said apparatus including:
at least one pivot arm that is pivotally mounted to pivot about a pivot axis that extends generally parallel to an upper edge of a container wall and to fold the upper edge of said wall during said pivotal movement, to form a ledge extending from the upper edge of said wall; and
a shift arrangement, configured to move the pivot arm in an outwardly direction that extends generally perpendicular to said wall, to press an end of a pillar tab against an inside of said wall with part of the pivot arm.

7. Apparatus according to claim 6, wherein said pivot arm is attached to a pivot shaft that extends along the pivot axis and the shift arrangement is configured to move the pivot shaft in said outwardly direction.

8. Apparatus according to claim 7, wherein a plurality of said pivot arms are attached to said pivot shaft, said pivot arms being configured to fold the entire ledge during turning of the shaft and to press the ends of two of the pillar tabs simultaneously against the inside of said wall.

9. Apparatus according to claim 6 or claim 7, wherein the pivot arm includes a first press formation that is configured to press against the upper edge of said wall to form the ledge, and a second press formation that is configured to press the end of the pillar tab against the inside of said wall.

10. Apparatus according to claim 9, wherein the first and second press formations are oriented perpendicularly to each other.

11. A method according to claim 3, wherein the pivot arm includes a first press formation and a second press formation, the step of folding the upper edge of said wall from the first pair, to form the ledge includes pressing the first press formation against the upper edge of the wall during said pivotal movement of the pivot arm and the step of pressing the end of the pillar tab against the inside of said wall includes pressing the second press formation against the end of the pillar tab.

12. A method according to claim 3 or claim 4, wherein the step of folding the pillar tab includes pivoting a pillar forming part about an axis that extends generally parallel to the corner in which the pillar is folded.

13. Apparatus according to claim 8, wherein the pivot arm includes a first press formation that is configured to press against the upper edge of said wall to form the ledge, and a second press formation that is configured to press the end of the pillar tab against the inside of said wall.

14. Apparatus according to claim 13, wherein the first and second press formations are oriented perpendicularly to each other.
